(19) United States
(12) Patent Application Publication
(10) Pub. No.: US 2008/0151845 A1
(43) Pub. Date: Jun. 26, 2008

(54) Co-existence management of multiple radios

(75) Inventors: Mikko Jaakkola, Lempaala (FI); Pekko Vehvilainen, Tampere (FI); Jari P. Leppanen, Nokia (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION

(21) Appl. No.: 11/643,644

(22) Filed: Dec. 20, 2006

(51) Int. Cl. H04Q 7/24; H04B 1/38; H04M 1/00; H04Q 7/20

(52) U.S. Cl. 370/338; 370/412; 455/41.2; 455/422.1; 455/436; 455/445; 455/561

(57) ABSTRACT

The present invention provides a method and apparatus that features initiating a device discovery process for attempting to establish a connection between two or more devices via short range communications technology, wherein at least one of the two or more devices having an existing link to another wireless network; and suspending the link to the other wireless network before starting the device discovery. One of the devices may be a node, point or terminal, including a station or access point. The wireless network may include a wireless local area network (WLAN), Bluetooth® (BT), ultra wide band (UWB), wireless USB or other suitable wireless network either now known or later developed in the future. The short range communications technology may include Bluetooth®, as well as other short range communications technology either now known or later developed in the future.

### BACKGROUND OF THE INVENTION

1. Field of Invention

The present invention relates to a wireless network environment, and more particularly provides a method and system for facilitating the operation of multiradio devices, nodes, points or terminals in a wireless local area network environment, including a method and system for avoiding interference/co-existence issues between two concurrently operating radios operating via a single radio interface/antenna.

In particular, the present invention relates to equipping radio subsystems of a multiradio device with means to be aware of each other and interact during various events so that whenever one of the radio subsystems require a significant amount of “air-time”, the other radio subsystem is made aware of the coming event and can react on the situation to either maintain connectivity to external network with controlled disassociation procedure, or perform a handover of the connection to another radio bearer (cellular radio) to ensure continuity of the service session.

2. Description of Related Art

Modern society has quickly adopted, and become reliant upon, handheld devices for wireless communication. For example, cellular telephones continue to proliferate in the global marketplace due to technological improvements in both the quality of the communication and the functionality of the devices. These wireless communication devices have become commonplace for both personal and business use, allowing users to transmit and receive voice, text and graphical data from a multitude of geographic locations. The communication networks utilized by these devices span different frequencies and cover different transmission distances, each having strengths desirable for various applications.

Cellular networks facilitate wireless communication over large geographic areas. These network technologies have commonly been divided by generations, starting in the late 1970s to early 1980s with first generation (1G) analog cellular telephones that provided baseline voice communication, to modern digital cellular telephones. GSM is an example of a widely employed 2G digital cellular network communicating in the 900 MHZ/1.8 GHZ bands in Europe and at 850 MHz and 1.9 GHZ in the United States. This network provides voice communication and also supports the transmission of textual data via the Short Messaging Service (SMS). SMS allows a WCD to transmit and receive text messages of up to 160 characters, while providing data transfer to packet networks, ISDN and POTS users at 9.6 Kbps. The Multimedia Messaging Service (MMS), an enhanced messaging system allowing for the transmission of sound, graphics and video files in addition to simple text, has also become available in certain devices. Soon emerging technologies such as Digital Video Broadcasting for Handheld Devices (DVB-H) will make streaming digital video, and other similar content, available via direct transmission to a WCD. While long-range communication networks like GSM are a well-accepted means for transmitting and receiving data, due to cost, traffic and legislative concerns, these networks may not be appropriate for all data applications.

Short-range wireless networks provide communication solutions that avoid some of the problems seen in large cellular networks. Bluetooth® is an example of a short-range wireless technology quickly gaining acceptance in the marketplace. A user does not actively instigate a Bluetooth® network. Instead, a plurality of devices within operating range of each other may automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master. These devices continually switch between various active communication and power saving modes in order to transmit data to other piconet members. In addition to Bluetooth® other popular short-range wireless networks include WLAN (of which “Wi-Fi” local access points communicating in accordance with various IEEE 802.11x standards, is an example), WUSB, UWB, ZigBee (802.15.4, 802.15.4a), and UHF RFID. All of these wireless mediums have features and advantages that make them appropriate for various applications.

In recent years, wireless LAN technology has become very popular because of its advantage in price and bandwidth. Nowadays, wireless LAN is mainly used for Internet access, but real-time application like Voice over IP (VoIP) and video on demand (Vod) are identified as the future applications for wireless LAN. To support such new applications, IEEE 802.11e was standardized to define a new 802.11 medium access control (MAC) layer protocol. The IEEE 802.11e MAC is a standard to support Quality of Service (QoS), and 802.11e Hybrid Coordination Function (HCF) can support QoS in 802.11 networks. The HCF provides both a contention-based channel access, called enhanced distributed channel access (EDCA), and a controlled channel access, referred to as HCF controlled channel access (HCCA).

Devices that use highly integrated chipset solutions, such as PDAs and mobile phones (referred later on this document with a generic term, handheld station or STA) the amount of radio receivers (Rx) and transmitters (Tx) and the antennas are kept small on purpose to make the STA compact in size and to save the additional costs that the implementation of several separate Rxs, Txs, and antennas would cause.

For example, the co-existence of Bluetooth® and WLAN radios in one product can present a problem. The Bluetooth® Inquiry is a process where a Bluetooth® device finds out what other Bluetooth® devices are surrounding it at the moment. Since Bluetooth® and WLAN operate on the same frequency band (roughly 2.4 GHz for both Bluetooth® and WLAN 802.11b/g implementations), they can divide the same Rx and Tx and the same RF antenna. However, this can cause problems when simultaneous operation with both systems is required. For instance, an active unlicensed module access (UMA) connection over the WLAN with a simultaneous Bluetooth® Inquiry request may cause a problem as follows:

When Bluetooth® Inquiry is performed (e.g. to find another Bluetooth® device to synchronize the PIM data with) while in active UMA connection over WLAN, the UMA data transfer may be significantly impaired because of Bluetooth® activity on the same frequency band (roughly 2.4 GHz for both Bluetooth® and WLAN 802.11b/g implementations). The Bluetooth® Inquiry can last up to 61.44 seconds (see the Bluetooth® Specification, Version 2.0+EDR [vol. 3]). Because of the simultaneous activity (the same RF resources need to be shared and the current implementations favor Bluetooth® over WLAN) the user will experience significantly impaired audio quality and/or call drop because of the activities. If user is transferring GPRS data over UMA (such as push eMail or file transfer) the data transfer is slowed down or stopped.

In particular, when WLAN and Bluetooth® are being attached to the same physical antenna, the Bluetooth® Inquiry operation will reserve the antenna fully for the time required for conducting device discovery according to the Bluetooth® Inquiry protocol, which will cause system to drop or severely damage the WLAN connection. The WLAN connection can be either dropped due to fact that WLAN device cannot hear beacons for certain period of time or WLAN Access Point (AP) is not being able to get acknowledgements from the WLAN devices to the packets that it has sent. Severe damage, in this context, may include e.g. a situation where rate adaptation is pushed to 1 Mbits/s due to fact that WLAN device has not sent acknowledgements to the WLAN AP packets. In WLAN/BT co-existence use-case it is very unlikely that system would recover from such situation (in some cases, there is 100% chance of collision when using 1 Mbits/s data rates).

Typically, in the prior art the above-mentioned problems have been ignored and the system has been configured in such way that Bluetooth® Inquiry will always have the priority over WLAN traffic, which causes problems including the examples mentioned above.

Moreover, there is no known prior art to solve this problem; instead there exists some somewhat related techniques, as follows:

US 20060194600, assigned to the assignee of the present invention, discloses a method and system for VoIP over WLAN to Bluetooth® headset using advanced eSCO scheduling, for reducing interference in simultaneous wireless LAN (WLAN) and wireless personal area network (PAN) signal handling in mobile wireless terminals having both a WLAN and a PAN interface. The wireless terminal includes a first transceiver operating in the PAN network in a communications band and a first communications protocol transmitting first data units. The wireless terminal also includes a second transceiver operating in the WLAN network in substantially the same communications band and a second communications protocol transmitting second data units. The wireless terminal further includes a controller coupled to the first and second transceivers, assigning a higher transmission priority to the second data units than to the first data units when transmission of the second data units overlaps a first occurring transmission of the first data units, to abort transmission of the first occurring data unit. The controller assigns a higher transmission priority to the aborted first data unit than to the second data units when transmission of the second data units overlaps the retransmission of the aborted first data unit, to transmit the aborted first data unit.

US 20060194538, assigned to the assignee of the present invention, discloses another method and system for VoIP over WLAN to Bluetooth® headset using ACL link and sniff for aligned eSCO transmission, for reducing interference in simultaneous wireless LAN (WLAN) and wireless personal area network (PAN) signal handling in mobile wireless terminals having both a WLAN and a PAN interface. The wireless terminal includes a first transceiver operating in the PAN network in a communications band and a first communications protocol transmitting first data units. The wireless terminal also includes a second transceiver operating in the WLAN network in substantially the same communications band and a second communications protocol transmitting second data units. The wireless terminal further includes a controller coupled to the first and second transceivers, assigning a higher transmission priority to the second data units than to the first data units when transmission of the second data units overlaps a first occurring transmission of the first data units, to abort transmission of the first occurring data unit. The controller assigns a higher transmission priority to the aborted first data unit than to the second data units when transmission of the second data units overlaps the retransmission of the aborted first data unit, to transmit the aborted first data unit.

US 20060084469 discloses a transmitter and receiver architecture for multi-mode wireless device, including a multi-mode wireless device having a transceiver including a multi-mode transmitter and a multi-mode receiver. The transmitter can include a multi-mode transmit baseband portion configured to support all of the transmit modes. Similarly, the receiver can include a multi-mode baseband portion that is configured to support all of the receive modes. The transmitter can also include a frequency conversion stage that can convert the output from the transmit baseband portion to the desired transmit frequency. Multiple power amplifiers in parallel, each configured to support one or more of the operating modes, can selectively amplify the transmit signals. The receiver can include multiple low noise amplifiers (LNAs) in parallel, each configured to selectively amplify the received signals of one or more of the operating modes. The output of the LNAs can be coupled to a frequency conversion stage that down converts the received signals and provides them to the baseband portion.

In view of this, there is a need in the industry to solve problems caused to WLAN operation due to Bluetooth® Inquiry reserving the radio interface as the WLAN and Bluetooth® radios are sharing the same antenna resource.

### SUMMARY OF THE INVENTION

The present invention provides a method and apparatus that features initiating a device discovery process for attempting to establish a connection between two or more devices via short range communications technology, wherein at least one of the two or more devices have an existing a link to another wireless network; and suspending the link to the other wireless network before starting the device discovery.

One of the devices may be a node, point or terminal, including a station or access point.

According to some embodiments of the present invention, the wireless network may include a wireless local area network (WLAN), Bluetooth® (BT), ultra wide band (UWB), wireless USB or other suitable wireless network either now known or later developed in the future.

The short range communications technology may include Bluetooth®, as well as other short range communications technology either now known or later developed in the future.

According to some embodiments of the present invention, the link may be restored after the device discovery.

According to some embodiments of the present invention, the device may include short range communications and wireless network subsystem modules that are aware of each other; and the wireless network subsystem may ask the short range communications subsystem to delay the start of the device discovery.

In some embodiments of the present invention, the device may include a station that disassociates with the existing link to an access point of a wireless local area network; all traffic destined to the station may be buffered in the access point until the station performs an association request after the connection; and during a disassociation process all the data sent to the wireless local area network substation may be either discarded or buffered depending on the type of traffic. Doing a new association request saves the system from not doing a full authorization process. In some embodiments according to the present invention, the initiating of the device discovery process may be disregarded in case the link to another wireless network provides a higher prioritization than the device discovery.

In some embodiments of the present invention, the device may be a station that fully deauthenticates itself from an access point of a wireless local area network but fakes to upper layers that the link is up; and after the connection is reestablished, a subsystem of the station does a new connection process from the beginning, and the previous session key from an authorization protocol may be valid.

In some embodiments of the present invention, the device may be connected via a handover procedure to another wireless network or radio bearer to ensure continuity of a service session. In this case, the other wireless network may include a global system for mobile communications (GSM) service, a general packet radio service (GPRS), Universal Mobile Telecommunications System (UMTS) packet network architecture, or other suitable mobile services. If the handover procedure to the other wireless network is not possible, then the at least one device notifies the user that the connection will be impaired or dropped if the link is made. Further, the handover procedure may be attempted in certain situations, including a voice over internet protocol (VoIP) call.

In effect, the whole thrust of the present invention is to tie the starting of the Inquiry to suspension of the WLAN link and after the Inquiry process has been done, the WLAN link will be restored, and to equip radio subsystems with means to be aware of each other and interact during various events so that whenever one of the radio subsystems require a significant amount of “air-time”, the other radio subsystem is made aware of the coming event and can react on the situation to either maintain connectivity to the external network with controlled disassociation procedure, or perform a handover of the connection to another radio bearer (cellular radio) to ensure continuity of the service session.

The present invention may also include implementing the method in apparatus such as, for example, a node, point, terminal or device, such as a station (STA), in a system having such a wireless network, including a wireless local area network (WLAN), that features one or more modules configured to initiate the device discovery process for attempting to establish a connection between two or more devices via short range communications technology, wherein at least one of the two or more devices having an existing link to another wireless network, and to suspend the link to the other wireless network before starting making the device discovery.

The present invention may also include implementing the same in a system or radio controller for facilitating communication in a wireless local area network, that features one or more modules configured to initiate the device discovery process for attempting to establish a connection between two or more devices via short range communications technology, wherein at least one device of the two or more devices having an existing link to another wireless network, and to suspend the link to the other wireless network before starting the device discovery. In particular, the radio controller may include one or more interfaces to one or more radio modules configured for detecting initiation of a device discovery process by any of the one or more radio modules attempting to establish a connection via short range communications technology with one or more other devices, the device having an existing link to another wireless network; and a module configured for instructing the one or more radio modules to suspend the link to the other wireless network before allowing start of the device discovery.

The scope of the invention may also include implementing the same in a computer program product with a program code, which program code is stored on a machine readable carrier, for carrying out the steps of the method according to the present invention. The method may also feature implementing the step of the method via a computer program running in a processor, controller or other suitable module in such a WLAN terminal.

In some embodiments according to the present invention, the method for facilitating concurrent communication of two or more interfering radio subsystems in a terminal device may feature receiving an indication of forthcoming device detection procedure to be initiated by a first radio module; and instructing a second radio module to perform a network interrupt operation to allow the first radio module to perform the device detection procedure, wherein the network interrupt operation comprises performing one of a network disassociation for enabling data to be communicated to during the network disassociation to be buffered until connection to the network is restored and handing service session to a different network.

The technique according to the present invention negates many of the impacts of the Bluetooth® Inquiry, when Bluetooth® Inquiry is happening during data-intensive moments. Moreover, the Bluetooth® Inquiry does not have the capability of destroying or damaging the WLAN connection. This is huge benefit for applications as occasional Inquiry can cause WLAN links to drop and applications might do some “intelligent” logic that forbid the application using the WLAN.

In total, the present invention provides a solution to the problem related to the WLAN operation due to Bluetooth® Inquiry enabling a radio interface when the WLAN and Bluetooth® radios are sharing the same antenna resource.

### BRIEF DESCRIPTION OF THE DRAWING

The drawing includes the following Figures, which are not necessarily drawn to scale:

FIG. 1a shows typical parts of an IEEE 802.11 WLAN system according to some embodiments of the present invention.

FIG. 1b shows typical parts of a UMA Vertical Handover, WLAN to GSM and vice versa according to some embodiments of the present invention.

FIGS. 2a and 2b show a flow charts of the basic steps of some embodiments of the present invention.

FIG. 3 shows a WLAN enabled device according to some embodiments of the present invention.

FIG. 4 shows an exemplary WLAN chip that forms part of the WLAN enabled device shown in FIG. 3 according to some embodiments of the present invention. FIG. 4a shows a diagram of a system having a BT/WLAN subsystem modules, a GSM/UMTS subsystem module, a shared antenna, another antenna and a radio controller module, according to some embodiments of the present invention.

FIGS. 5a and 5b show diagrams of the Universal Mobile Telecommunications System (UMTS) packet network architecture according to some embodiments of the present invention.

### BEST MODE OF THE INVENTION

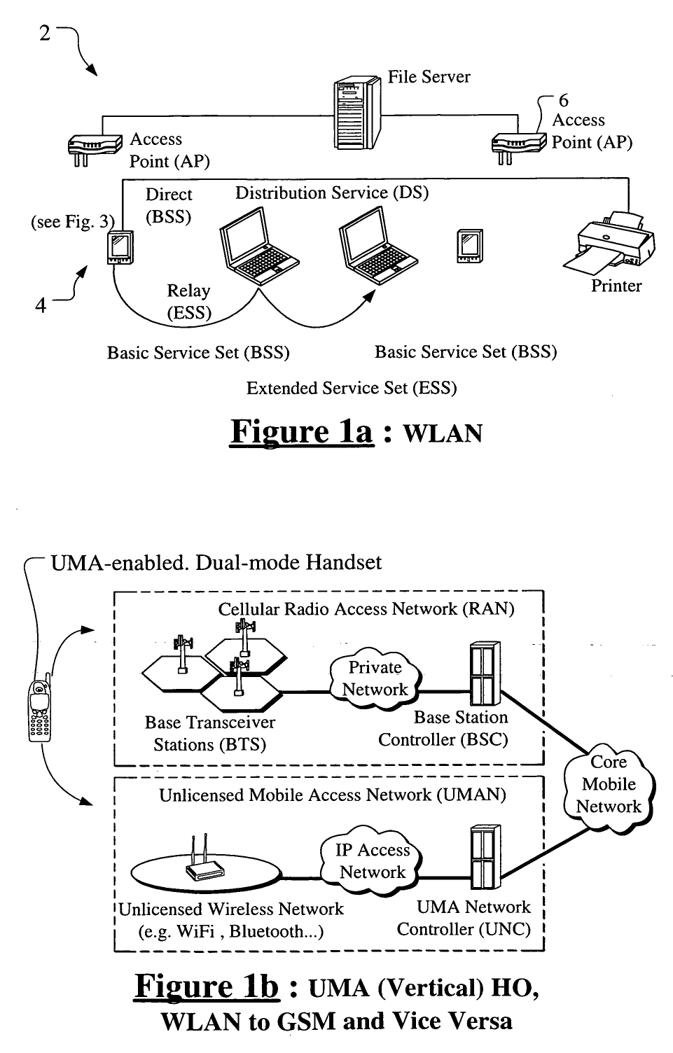

FIG. 1 shows, by way of example, a wireless network according to the present invention in the form of an IEEE 802.11 WLAN system, generally indicated as 2, which provides for communications between communications equipment such as mobile and secondary devices generally indicated as 4, including personal digital assistants 4a (PDAs), laptops 4b and printers 4c, etc. The WLAN system 2 may be connected to a wired LAN system that allows wireless devices to access information and files on a file server or other suitable device or connecting to the Internet. The devices can communicate directly with each other in the absence of a base station in a so-called “ad-hoc” network, or they can communicate through a base station, called an access point (AP) in IEEE 802.11 terminology, generally indicated as 6, with distributed services through the AP 2 using local distributed services (DS) or wide area extended services, as shown. In a WLAN system, end user access devices are known as stations 4 (STAs), which are transceivers (transmitters/receivers) that convert radio signals into digital signals that can be routed to and from communications device and connect the communications equipment to access points (APs) that receive and distribute data packets to other devices and/or networks. The STAs 4 may take various forms ranging from wireless network interface card (NIC) adapters coupled to devices to integrated radio modules that are part of the devices, as well as an external adapter (USB), a PCMCIA card or a USB Dongle (self contained), which are all known in the art. It is important to note that the scope of the invention is intended to include implementing the same in other types or kinds of wireless networks, including wireless short-range communication networks like Bluetooth® (BT), ultra wide band (UWB), wireless USB or other suitable wireless networks either now known or later developed in the future.

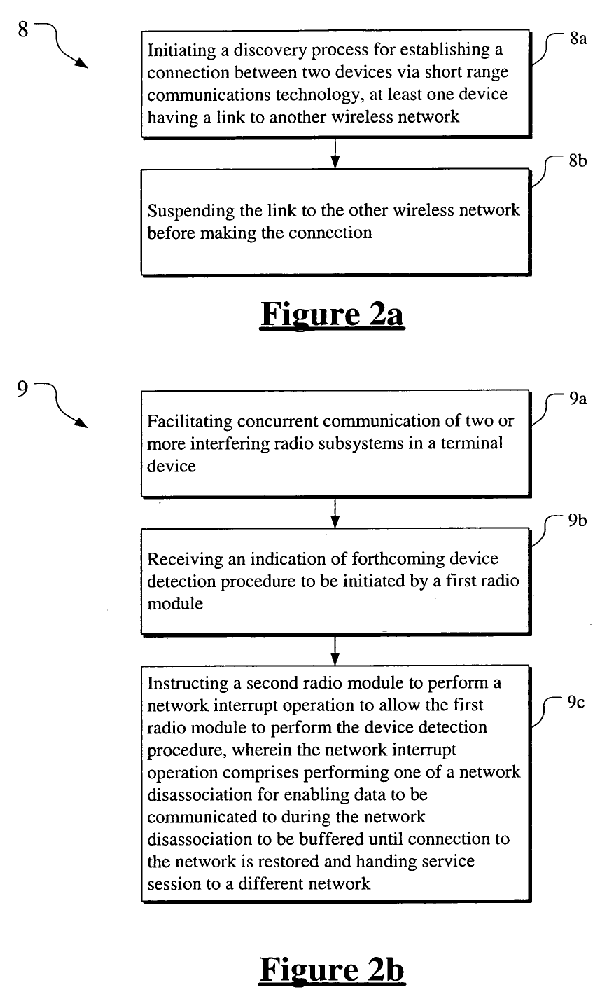

FIGS. 2A and 2B show flowcharts generally indicated as 8 and 9 having the basic steps 8a and 8b and 9a, 9b and 9c respectively for implementing the inventive method according to some embodiments of the present invention. It is understood that the method may include other steps known in the art that do not form part of the underlying invention, including, but not limited to the connection establishment in relation to FIG. 2A, which may require additional steps to the Bluetooth® inquiry, including paging and SDP wherein the WLAN subsystem is allowed to operate, e.g. after the Bluetooth® inquiry has been conducted.

### The Basic Implementation

The present invention may be implemented, by way of example, as follows:

### The Suspension

The idea according to some embodiments of the present invention is to tie the starting of the Bluetooth® Inquiry process to controllable suspension of the WLAN link and after the Bluetooth® Inquiry process has been done, the WLAN link will be restored.

A first part of the implementation is to make the Bluetooth® and WLAN-subsystem aware of each so that WLAN subsystem is aware of the Bluetooth® Inquiry intentions of the Bluetooth® subsystem. In some cases, the WLAN subsystem could ask the Bluetooth® subsystem to delay the process, e.g. in the case of an active voice call, but in the typical case the WLAN subsystem would prepare itself for link suspension.

There are two basic methods of implementing link suspension according to some embodiments of the present invention. The first method is to perform disassociate with the WLAN AP and that way cause the link to be temporarily suspended. All the traffic destined to the station would be buffered in the WLAN AP until the station would be performing association request after the Bluetooth® Inquiry is over. During the disassociation process all the data send from the TCP/IP-stack to the WLAN subsystem could be either discarded or buffered by WLAN subsystem depending on the type of traffic. Doing only a new association request would save the system from not doing the full authentication process and that way to be more transparent from the system point of view.

The second method would be for the mobile device to fully deauthenticate itself from the WLAN AP but still fake to upper layers that the link is up. After the Bluetooth® Inquiry is over, the WLAN subsystem would do connection establishment process from the beginning. Typically, the previous session key from extensible authentication protocol (EAP)-authentication would be valid and that way this would not cause significant overhead to the system. Most likely also the previous DHCP provided IP-address would still be reserved for the terminal and that way the higher-layer protocols wouldn't experience any disruptions in their operation.

### The Handover

In certain situations, such as when in a VoIP call, the WLAN subsystem cannot be switched off as the call would be lost. In such a situation, the node, point, terminal or device could initiate a handover from a WLAN bearer to a wide-area network bearer so that the ongoing voice call is not lost (although QoS might be reduced as there is not necessarily a VoIP call option available with wide-area network bearer).

With such a handover, the initially WLAN-based service session can be continued using wide-area network bearer while the Bluetooth® subsystem performs the Inquiry procedure.

In particular, some embodiments of the present invention may include the following:

1. When a user makes a Bluetooth® Inquiry with a wireless device (STA) while in an active UMA connection (either in a call or transferring other data), the STA should make a vertical handover (HO) from the WLAN to another UMA compatible system such as GSM or UMTS, see FIG. 1b.

2. When the Bluetooth® Inquiry process is over, the handheld station may roam back to WLAN again.

3. If the HO to another system is not possible, the user should be notified via a user interface (UI) and/or with sound that the UMA connection will be impaired or dropped if the Bluetooth® Inquiry is made.

When Bluetooth® Inquiry is initiated and the UMA connection is active, the local Bluetooth® subsystem server in the STA software (SW) should notify the local UMA subsystem server in the STA SW to HO from the WLAN to another system such as to GSM (vertical HO). If the HO procedure is not possible, the local UMA subsystem server may send a notification to Bluetooth® subsystem server and to the user interface (UI) that the HO is not possible. If the vertical HO succeeds, the UMA subsystem server may notify the Bluetooth® subsystem server that the HO has been completed successfully.

The STA SW may also be implemented to perform the following functionality:

1. The Bluetooth® subsystem server SW may check the status of UMA connection before initiating Bluetooth® Inquiry.

2. The UMA subsystem server SW may notify the Bluetooth® and WLAN subsystem servers about the success of the HO.

3. The UI and Sound subsystem servers SW may notify the user in those cases when HO is not possible.

4. The UMA subsystem server SW may be adapted so that when the Bluetooth® subsystem server SW indicates that the Inquiry has finished, the HO to WLAN can be made.

In this embodiment, the user can search for Bluetooth® capable devices with the Bluetooth®Inquiry without the UMA connection being impaired or interrupted.

### Device implementation

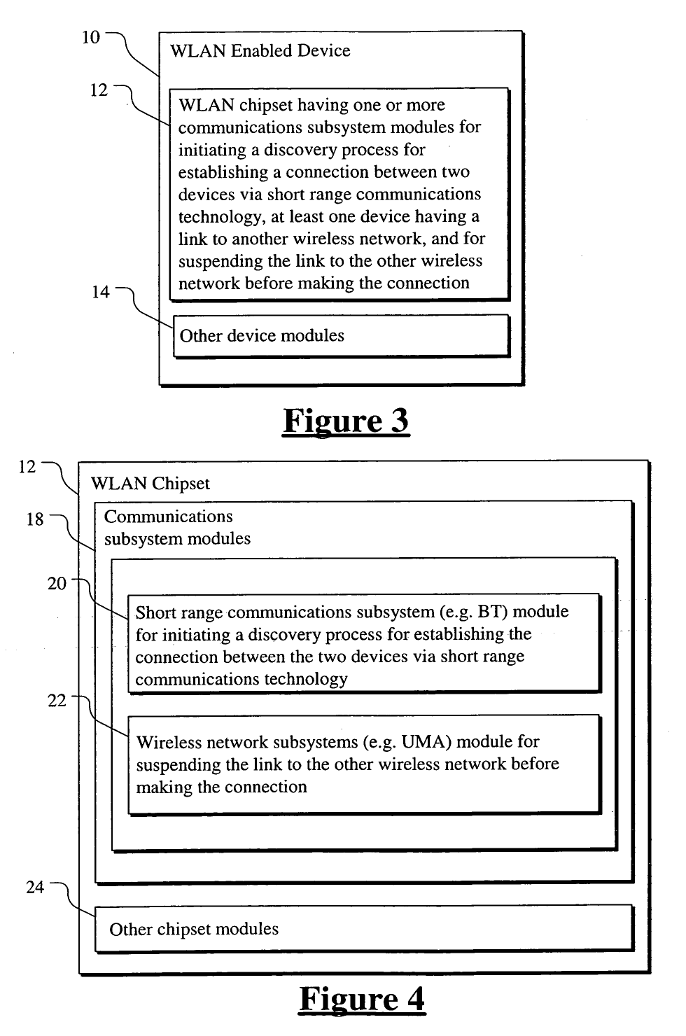

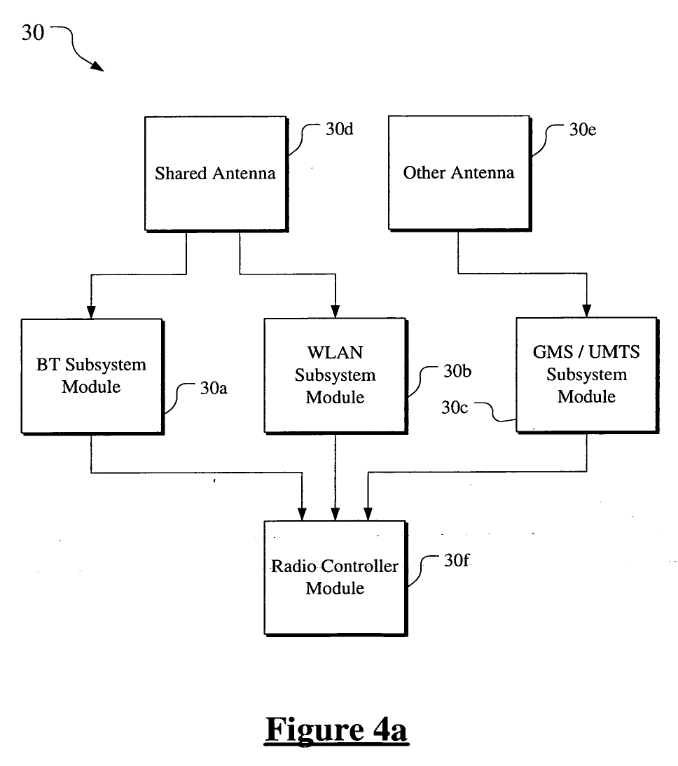

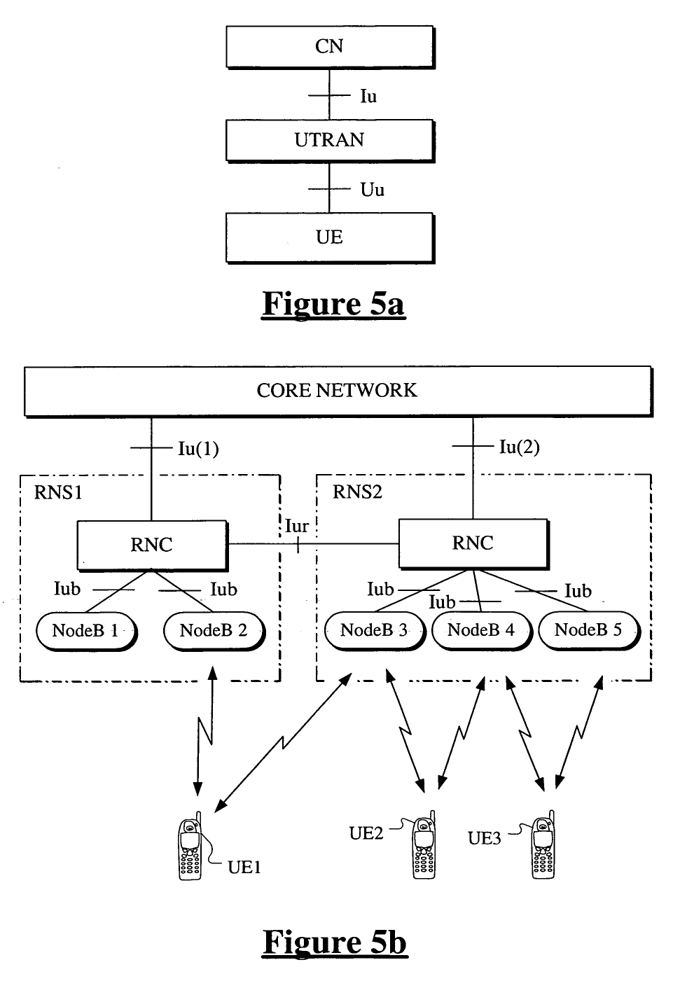

FIG. 3 shows a node, point, terminal or device 4 in the form of a WLAN enabled device generally indicated 10 according to some embodiments of the present invention for a wireless local area network (WLAN) or other suitable network such as that shown in FIGS. 1, 5a and 5b. The WLAN enabled device 10 has a WLAN chipset 12 for performing radio controller functionality with one or more communications subsystem modules 18 (see FIG. 4) that are configured for initiating a device discovery process for attempting to establish the connection between the two or more devices via the short range communications technology, wherein at least one of the two or more devices has an existing link to the other wireless network, and for suspending the link to the other wireless network before starting the device discovery. Consistent with that described above, the WLAN enabled device 10 may take the form of a station (STA) or other suitable node, point, terminal or device either now known or developed in the future for operating in such a wireless local area network (WLAN) or other suitable network such as that shown in FIGS. 1, 5a and 5b. The WLAN enabled device 10 may also have other device modules 14 that do not necessarily form part of the underlying invention and are not described in detail herein, including a shared antenna between at least two radio subsystems such as a BT subsystem and a WLAN subsystem.

FIG. 4 shows, by way of example, the WLAN chipset 12 in further detail, where the communications subsystem modules 18 includes one or more short range communications modules 20 configured for initiating the device discovery process for attempting to establish the connection between the two or more devices via short range communications technology, according to some embodiments of the present invention. The communications subsystem modules 18 also includes one or more wireless network subsystem modules 22 for suspending the link to the other wireless network before starting the device discovery, according to some embodiments of the present invention. In operation, the modules 20 and 22 cooperate consistent with that shown and described herein for implementing some embodiments of the present invention. The WLAN chipset 12 may also include other chipset modules 24 that do not necessarily form part of the underlying invention and are not described in detail herein, including by way of example a shared antenna between the two radio subsystems or modules 20 and 22, a baseband module, a MAC module, a host interface module. Although the present invention is described in the form of one or more stand alone modules for the purpose of describing the same, the scope of the invention is invention is intended to include the functionality of the one or more communications subsystem modules 18 being implemented in whole or in part by one or more of these other chipset modules 24. In other words, the scope of the invention is not intended to be limited to where the functionality of the present invention is implemented in the WLAN chipset 12.

FIG. 4a shows, by way of example, a system generally indicated as 30 having a BT subsystem module 30a, a WLAN subsystem module 30b, a GSM/UMTS subsystem module 30c, a shared antenna 30d, another antenna 30e and a radio controller module 30f, where one antenna 30d is connected between both BT & WLAN subsystem modules 30a and 30b, where the other separate antenna 30e is connected to the wide-area network subsystem module 30c, and where the radio controller module 30f forms a control link between the BT & WLAN subsystem modules 30a and 30b and the WLAN & GSM/UMTS subsystem modules 30b and 30c. According to some embodiments of the present invention, the radio controller module 30f takes the form of one dedicated controller (multiradio controller) responsible for managing the operations of the various radio subsystems 30a, 30b and 30c, as shown.

### Implementation of the Functionality of Modules 18, 20 and 22

By way of example, and consistent with that described herein, the functionality of the modules 18, 20 and 22 may be implemented using hardware, software, firmware, or a combination thereof, although the scope of the invention is not intended to be limited to any particular embodiment thereof. In a typical software implementation, the modules 18, 20 and 22 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 18, 20 and 22 being a stand alone module, as shown, or in the combination with other circuitry for implementing another module. Moreover, the real-time part may be implemented in hardware, while non real-time part may be done in software.

The other chipset modules 24 may also include other modules, circuits, devices that do not form part of the underlying invention per se. The functionality of the other modules, circuits, device that do not form part of the underlying invention are known in the art and are not described in detail herein.

### The WLAN Chipset

The present invention may also take the form of the WLAN chipset 12 for a node, point, terminal or device in a wireless local area network (WLAN) or other suitable network, that may include a number of integrated circuits designed to perform one or more related functions. For example, one chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such a node, point, terminal or device.

### Universal Mobile Telecommunications System (UMTS) Packet Network Architecture

FIGS. 5a and 5b show diagrams of the Universal Mobile Telecommunications System (UMTS) packet network architecture. In FIG. 5a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 5b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 5a. A given UE may be in radio contact with multiple Node Bs even if one or more of the Node Bs are connected to different RNCs. For instance, a UE1 in FIG. 5b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 5a and 5b has resulted in STAs taking the form of UEs, such as mobile phones or mobile terminals. The interworking of the WLAN (IEEE 802.11) shown in FIG. 1 with such other technologies (e.g. 3GPP, 3GPP2 or 802.16) such as that shown in FIGS. 5a and 5b is being defined at present in protocol specifications for 3GPP and 3GPP2. The scope of the invention is intended to include implementing the same in such a UMTS packet network architecture as shown in FIGS. 5a and 5b. UMA

For the purpose of understanding the present invention, it is noted that Unlicensed Mobile Access (UMA) technology is known in the art and enables access to GSM and GPRS mobile services over unlicensed spectrum, including Bluetooth® and WLAN. UMA is also referred as Generalized Access Network (GAN) in 3GPP standards. Highlights of the UMA technology include the follows:

Seamless delivery of mobile voice and data services over unlicensed wireless networks.

Provides the same mobile identity on Cellular RAN and unlicensed wireless networks.

Seamless transitions (roaming and handover) between Cellular RAN and unlicensed wireless networks, see FIG. 1b.

Preserves investment in existing/future mobile core network infrastructure.

Independent of underlying unlicensed spectrum technology (e.g. WiFi™, Bluetooth®).

Transparent to existing, standard CPE devices (e.g. access points, routers and modems).

Utilizes standard “always on” broadband IP access networks (e.g. DSL, Cable, T1/E1, Broadband Wireless, FTTH . . . ).

Security equivalent to current GSM mobile networks.

No impact to operations of Cellular RAN (e.g. spectrum engineering, cell planning, . . . )

### UMA Technology Operation

The UMA technology provides alternative access to GSM and GPRS core network services via IP-based broadband connections. In order to deliver a seamless user experience, the specifications define a new network element (the UMA Network Controller, UNC) and associated protocols that provide for the secure transport of GSM/GPRS signalling and user plane traffic over IP. The UNC interfaces into the core network via existing 3GPP specified A/Gb interfaces.

### UMA Interoperability

An open test specification is under development that can be used to facilitate interoperability testing between implementations. The test specification will be available through this web site. Companies planning to implement products based on the UMA specifications should seek bilateral compliancy testing agreements directly with other vendors.

In principle, the UMA specifications ensure interoperability similar to any other industry specifications, but the specifications may include options and parameters that have to be agreed bilaterally with other vendors. The UMA participating companies do not guarantee interoperability and the specifications may be upgraded without notice.

### List of Abbreviations

The following is a list of abbreviations:

TABLE 1
List of abbreviations

| | |
|---|---|
| AP | Access Point |
| BER | Bit Error Rate |
| BSA | Basic Service Area |
| BSS | Basic Service Set |
| BT | Bluetooth ® |
| dBm | deciBels referred to 1 mW |
| DS | Distribution System |
| ESS | Extended Service Set |
| FIFO | First In First Out |
| GAN | Generalized Access Network |
| GPRS | General Packet Radio Service |
| GSM | Global System for Mobile communications |
| HO | HandOver |
| IEEE | Institute of Electrical and Electronics |
| | Engineers |
| MAC | Medium Access Control |
| MCU | Micro Controller Unit |
| PC | Personal Computer |
| PHY | Physical layer |
| PDA | Personal Digital Assistant |
| RCPI | Received Channel Power Indicator |
| RF | Radio Frequency |
| RSSI | Received Signal Strength Indicator |
| STA | Station |
| SW | Software |
| UMA | Unlicensed Medium Access |
| WLAN | Wireless Local Area Network |

### SCOPE OF THE INVENTION

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What is claimed is:

1. A method comprising:
initiating a device discovery process for attempting to establish a connection between two or more devices via short range communications technology, wherein at least one of the two or more devices have an existing link to another wireless network; and
suspending the link to the other wireless network before starting the device discovery.

2. A method according to claim 1, wherein the other wireless network is a wireless local area network (WLAN).

3. A method according to claim 1, wherein the short range communications technology is Bluetooth®.

4. A method according to claim 1, wherein the link is restored after the device discovery.

5. A method according to claim 1, wherein the at least one device includes short range communications and wireless network subsystem modules that are aware of each other.

6. A method according to claim 5, wherein the wireless network subsystem asks the short range communications subsystem to delay the start of the device discovery.

7. A method according to claim 1, wherein the at least one device is connected via a handover procedure to another wireless network or radio bearer to ensure continuity of a service session.

8. A method according to claim 7, wherein the other wireless network includes a global system for mobile communications (GSM) service, a general packet radio service (GPRS), Universal Mobile Telecommunications System (UMTS) packet network architecture, or other suitable mobile services.

9. A method according to claim 7, wherein, if the handover procedure to the other wireless network is not possible, then the at least one device notifies the user that the connection will be impaired or dropped if the link is made.

10. A method according to claim 1, wherein the initiating of the device discovery process is disregarded in case the link to another wireless network provides a higher prioritization than the device discovery.

11. A method according to claim 7, wherein the handover procedure is attempted in certain situations, including a voice over internet protocol (VoIP) call.

12. A system comprising:
a first device; and
a second device;
the first device initiating a device discovery process for attempting to establish a connection via short range communications technology with the second device, the first device having an existing link to another wireless network; and
the first device suspending the link to the other wireless network before starting the device discovery.

13. A system according to claim 12, wherein said first device is a station that disassociates the existing link to an access point of a wireless local area network (WLAN).

14. A system according to claim 13, wherein all traffic destined to the station is buffered in the access point until the station performs an association request after the connection.

15. A system according to claim 13, wherein during a disassociation process all the data sent to the wireless local area network substation is either discarded or buffered depending on the type of traffic.

16. A device comprising:
one or more modules configured for initiating a device discovery process for attempting to establish a connection via short range communications technology with one or more other devices, the device having an existing link to another wireless network; and
a module configured for suspending the link to the other wireless network before starting the device discovery.

17. A device according to claim 16, wherein the device is a node, point or terminal, including a station or access point.

18. A device according to claim 16, wherein the other wireless network is a wireless local area network (WLAN).

19. A device according to claim 16, wherein the short range communications technology is Bluetooth®.

20. A device according to claim 16, wherein the link is restored after the device discovery.

21. A device according to claim 16, wherein the at least one device has short range communications and wireless network subsystem modules that are aware of each other.

22. A device according to claim 26, wherein the wireless network subsystem asks the short range communications subsystem to delay the establishment of the connection.

23. A device according to claim 16, wherein the device is a station that disassociates the existing link to an access point of a wireless local area network (WLAN).

24. A device according to claim 16, wherein during a disassociation process all data sent to the wireless local area network subsystem is either discarded or buffered depending on the type of traffic.

25. A device according to claim 16, wherein the at least one device is connected via a handover procedure to another wireless network or radio bearer to ensure continuity of a service session.

26. A device according to claim 25, wherein the other wireless network includes a global system for mobile communications (GSM) service, a general packet radio service (GPRS), Universal Mobile Telecommunications System (UMTS) packet network architecture, or other suitable mobile services.

27. A device according to claim 25, wherein, if the handover procedure to the other wireless network is not possible, then the device notifies the user that the connection will be impaired or dropped if the link is made.

28. A device according to claim 25, wherein the handover procedure is attempted in certain situations, including a voice over internet protocol (VoIP) call.

29. A device according to claim 16, wherein the device shares a single radio interface/antenna resource between its short range communications technology and its wireless network technology.

30. A device according to claim 16, wherein the device disregards the initiating of the device discovery process in case the link to another wireless network provides a higher prioritization than the device discovery.

31. A radio controller for a device comprising:
one or more interfaces to one or more radio modules configured for detecting initiation of a device discovery process by any of the one or more radio modules for attempting to establish a connection via short range communications technology with one or more other devices, the device having an existing link to another wireless network; and
a module configured for instructing the one or more radio modules to suspend the link to the other wireless network before allowing start of the device discovery.

32. A radio controller according to claim 31, wherein the other wireless network is a wireless local area network (WLAN).

33. A radio controller according to claim 31, wherein the short range communications technology is Bluetooth®.

34. A radio controller according to claim 31, further comprising a module for instructing the one or more radio modules to restore the link after the device discovery.

35. A radio controller according to claim 31, further comprising a module instructing the short range communications subsystem to delay the start of the device discovery.

36. A radio controller according to claim 31, further comprising a module for instructing the one or more radio modules to initiate a handover procedure to another wireless network or radio bearer to ensure continuity of a service session.

37. A radio controller according to claim 36, wherein the other wireless network includes a global system for mobile communications (GSM) service, a general packet radio service (GPRS), Universal Mobile Telecommunications System (UMTS) packet network architecture, or other suitable mobile services.

38. A radio controller according to claim 31, further comprising means for disregarding the initiating of the device discovery process in case the link to another wireless network provides a higher prioritization than the device discovery.

39. A radio controller according to claim 36, wherein the handover procedure is attempted in certain situations, including a voice over internet protocol (VoIP) call.

40. A radio controller according to claim 31, wherein the device shares a single radio interface/antenna resource between its short range communications technology and its wireless network technology.

41. A computer program product with a program code, which program code is stored on a machine readable carrier, for carrying out the steps of a method comprising one or more steps for initiating a device discovery process for attempting to establish a connection with one or more other devices via short range communications technology, wherein a link to another wireless network already exists; and suspending the link to the other wireless network before starting the device discovery, when the computer program is run in a module of either a node, point, terminal or device, such as a station (STA).

42. A method according to claim 1, wherein the method further comprises implementing the step of the method via a computer program running in a processor, controller or other suitable module in one or more network nodes, points, terminals or elements in the wireless LAN network.

43. Apparatus comprising:
means for initiating a device discovery process for attempting to establish a connection with one or more other devices via short range communications technology, the device having an existing link to another wireless network; and
means for suspending the link to the other wireless network before starting the device discovery.

44. Apparatus according to claim 43, wherein the other wireless network is a wireless local area network (WLAN).

45. Apparatus according to claim 43, wherein the short range communications technology is Bluetooth®.

46. A method comprising:
facilitating concurrent communication of two or more interfering radio subsystems in a terminal device;
receiving an indication of forthcoming device detection procedure to be initiated by a first radio module; and
instructing a second radio module to perform a network interrupt operation to allow the first radio module to perform the device detection procedure, wherein the network interrupt operation comprises performing one of a network disassociation for enabling data to be communicated to during the network disassociation to be buffered until connection to the network is restored and handing service session to a different network.
